(19) United States
(12) Patent Application Publication
(10) Pub. No.: US 2012/0130880 A1
(43) Pub. Date: May 24, 2012

(54) Systems and Methods for Product-Level and Contract-Level Risk Computations and Management

(75) Inventors: Andrea C. Garlanger, Chicago, IL (US); Patricia A. Messina, Chicago, IL (US); Bharat Mittal, Schaumburg, IL (US)

(73) Assignee: TRADING TECHNOLOGIES INTERNATIONAL, INC., Chicago, IL (US)

(21) Appl. No.: 12/952,816

(22) Filed: Nov. 23, 2010

(51) Int. Cl. G06Q 40/00

(52) U.S. Cl. 705/37

(57) ABSTRACT

Various systems and methods are described herein for product-level and contract-level risk checks. The product-level and contract-level risk checks are used to either allow or prevent a trading strategy to proceed. When a trading strategy is initiated, quoting and hedge orders to be entered in relation to the trading strategy are grouped based on their association with the same contract or the same product. Then, a long position and a short position are determined for each quoting order on order quantities of a quoting order and each hedge order that is triggered by the quoting order at the product level and the contract level. The long or short position that are contributed by the hedge orders of each quoting order may then be offset by the quantity of the quoting order in the same product or the same contract. The computed values are then used to determine the worst case net product position and/or worst case contract position for the trading strategy.

### FIELD OF INVENTION

The present patent document is directed towards electronic trading. More particularly, the present patent document relates to tools and features for risk management of a trading strategy.

### BACKGROUND

An electronic trading system generally includes one or more trading devices in communication with an electronic exchange (or multiple electronic exchanges). By way of illustration, an electronic exchange receives trade orders from trading devices, such as a client device, gateway, or a server collocated with the electronic exchange. Upon receiving a trade order, the electronic exchange enters the trade order into an exchange order book and attempts to match quantity of the trade order with one or more contra-side orders. A sell order is contra-side to a buy order with the same price. Similarly, a buy order is contra-side to a sell order with the same price.

Users of electronic trading systems often employ risk management techniques to manage or limit risk associated with electronic trading. However, current risk management techniques have disadvantages that may result in many unfavorable outcomes including, for example, too much risk being taken out of the available risk account balance. This may preclude a trader from submitting new orders based on the remaining risk balance.

### SUMMARY

Various embodiments that are described herein include systems and methods for pre-execution risk management of trading strategies in an electronic trading environment. According to an example embodiment, a product-level risk check and management are performed for a trading strategy. According to another example embodiment, a contract-level risk check and management are performed for a trading strategy.

As used herein, a trading strategy might define a relationship between two or more tradeable objects to be traded. Based on the defined relationship, a trading strategy may involve placing at least one order (“a quoting order”) at an electronic exchange, and then an offsetting a fill (e.g., either a complete or partial fill) of that order with the placement of one or more subsequent orders (“hedge orders”) in one or more tradeable objects. In another example, a trading strategy might involve buying or selling a first tradeable object and selling or buying a second tradeable object, where the first tradeable object is different from the second tradeable object. Regardless of the trading strategy, each tradeable object of the trading strategy may be referred to herein as “legs” of the trading strategy.

Currently, when a user or an automatic trading tool enters an order for a trading strategy, a risk checking tool performs various pre-trade risk checks before any order is sent to the market for the trading strategy. Typically, pre-trade risk checking takes into account all possible orders to be entered for the trading strategy, e.g., all quoting orders and all hedge orders to be entered when the corresponding quoting order is filled. Risk checking of all orders, including hedge orders, before any orders related to a trading strategy are sent to the market has a number of benefits. For example, when a risk-checked hedge order is to be sent to the market, it may be sent to the market without any additional delays due to risk checking. Additionally, a risk-checked hedge order will not be rejected due to risk limits, because it has been risk-checked before any orders were sent for a trading strategy.

Pre-trade risk checking often includes calculating the worst case net product position (“WCNPP”) and the worst case contract position (“WCCP”) and comparing the calculated values to their respective preset limits. The worst case positions calculated at the product and contract levels may include the worst case long and short positions. Typically, when calculating the worst case positions for a trading strategy, the worst case fill scenario is assumed in relation to orders to be entered for the trading strategy. For example, if a two-legged spread includes a buy quoting leg and a sell hedge leg, it may be assumed that the worst case long position is created for the spread when an order quantity of a buy order in the buy quoting leg is filled, and no quantity is filled in the sell hedge order to be entered when the buy order is filled. Then, it may be assumed that the worst case short position is created for the spread when the order quantity submitted in the sell hedge leg is filled.

While there are apparent benefits of risk checking all orders of a trading strategy prior to any order being submitted to an electronic exchange, risk managers must often increase the available risk limits for a trader to be able to execute all desired trading strategies. In many cases, such an approach is acceptable as the calculated worst case position is a true reflection of the risk associated with orders of a trading strategy. In other cases, such as when determining the WCNPP associated with a trading strategy that involves trading more than one contract of the same product, the existing WCNPP calculations may be overly conservative. Similar problems exist with respect to the existing risk calculations of the WCCP for a trading strategy that includes the same contract in two or more legs, such as, for example, when a spread is created to spread a specific contract versus an exchange provided spread that includes the same contract.

The embodiments described herein use the offsetting relationship between a quoting order and its corresponding hedges to lower the WCNPP or WCCP risk requirements associated with a trading strategy when the quoting order and its hedge order(s) correspond to the same product or the same contract, respectively. More specifically, the WCNPP and WCCP calculations described herein take into account that a hedge order is not entered into the market unless its corresponding quoting order is filled. Referring back to the two-legged spread example provided above, when calculating the worst case short position for the spread, the quoting order may be used to offset the short position created with the hedge order, thus, lowering the worst case short position calculated for the spread.

According to one embodiment, to determine the WCNPP for a trading strategy, a risk application may first group all legs of the trading strategy that correspond to the same product, e.g., contracts associated with different delivery months of the same product. The risk application may then determine a long WCNPP and a short WCNPP associated with each quoting order of the trading strategy by considering a quoting order and its corresponding hedge orders that are triggered when each leg's quoting order is filled. The calculated long or short WCNPP created with the hedge orders may then be offset by their corresponding quoting order to account for the offsetting relationship between the quoting order and its hedge orders. For example, if a quoting order is a sell, the quoting order may be used to offset a long WCNPP calculated for hedge orders corresponding to the quoting order. Similarly, if a quoting order is a buy, the quoting order may be used to offset a short WCNPP calculated for the hedge orders corresponding to the quoting order. The amount by which the long or short WCNPP is offset may be based on a spread ratio corresponding to the quoting leg, e.g., the quantity of the quoting leg in relation to other legs. Once the calculations are performed for each quoting order and its hedge orders, the overall WCNPP may be determined for the trading strategy based on the calculated long and short WCNPP. Then, the overall WCNPP may be used to determine if a product risk limit would be exceeded if the trading strategy was executed. If the limit would not be exceeded by executing the trading strategy, the trading strategy is approved for execution. Otherwise, the trading strategy is rejected.

According to another example embodiment, to determine the WCCP for a trading strategy, a risk application may first group all legs of the trading strategy that include the same contract, such as the same delivery month of the same product. The risk application may then determine a long WCCP and a short WCCP related to each quoting order by considering each quoting order and its hedge orders that are triggered when each respective quoting order is filled. The calculated long or short position WCCP created with the hedge orders may then be offset by their corresponding quoting order. For example, if a quoting order is an order to buy a contract, the quoting order may be used to offset the short WCCP calculated for its corresponding hedge orders to sell the contract when the quoting order is filled. Similarly, if a quoting order is an order to sell a contract, the quoting order may be used to offset the long WCCP calculated for hedge orders to buy the contract when the quoting order is filled. The amount by which the long or short WCCP is offset by the quoting order may be based on a spread ratio corresponding to the quoting leg, e.g., the quantity of the quoting leg in relation to other legs. Once the calculations are performed in relation to each quoting order, the overall long and short WCCP may be determined based on the calculated values. The long and short WCCP may be used to determine if the corresponding contract risk limit would be exceeded if the trading strategy was executed. If the limit would not be exceeded by executing the trading strategy, the trading strategy is approved for execution. Otherwise, the trading strategy is rejected.

Reference herein to “one embodiment,” “an embodiment,” or “an example embodiment,” means that a particular feature, structure, or characteristic described in connection with the embodiment can be included in at least one embodiment of the invention. The appearances of these phrases in various places of the specification are not necessarily all referring to the same embodiment, nor are separate or alternative embodiments mutually exclusive. Instead, various embodiments described herein may be combined with other embodiments. The individual embodiments, as well as combinations thereof, are all intended to be within the scope of this patent document.

### BRIEF DESCRIPTION OF THE DRAWINGS

Example embodiments are described herein with reference to the following drawings.

FIG. 1 illustrates a flowchart of a method for trading in an electronic trading environment using a product-level risk check according to certain embodiments of the present invention;

FIG. 2 illustrates a flowchart of a method for trading in an electronic trading environment using a contract-level risk check according to certain embodiments of the present invention; and

FIG. 3 illustrates an example electronic trading system in which certain embodiments of the present invention may be employed.

The foregoing will be better understood when read in conjunction with the drawings which show certain embodiments of the present invention. The drawings are for the purpose of illustrating certain embodiments, but it should be understood that the present invention is not limited to the arrangements and instrumentality shown in the drawings.

### DETAILED DESCRIPTION

Embodiments provided herein include systems, methods, and computer readable media for pre-execution risk management of a trading strategy in an electronic trading environment. More specifically, the pre-execution risk management includes using more accurate methods to calculate WCNPP and/or WCCP for a trading strategy.

As used herein, a “tradeable object” refers to anything that can be traded with a price, a quantity, or both price and quantity. For example, financial products such as various stocks, options, bonds, futures, currency, warrants, funds derivatives, commodities, and collections and/or combinations of these may be tradeable objects. Each product may include various contracts. For example, a futures product may include contracts having different expiration dates. A tradeable object may be “real” or “synthetic.” A real tradeable object includes products or contracts that are listed by an exchange. A synthetic tradeable object includes products or contracts that are defined by the user and are not listed by an exchange. For example, a synthetic tradeable object may include a combination of real (or synthetic) products such as a synthetic spread. A tradeable object may also include traded events or goods.

### I. Worst Case Product Position Calculations

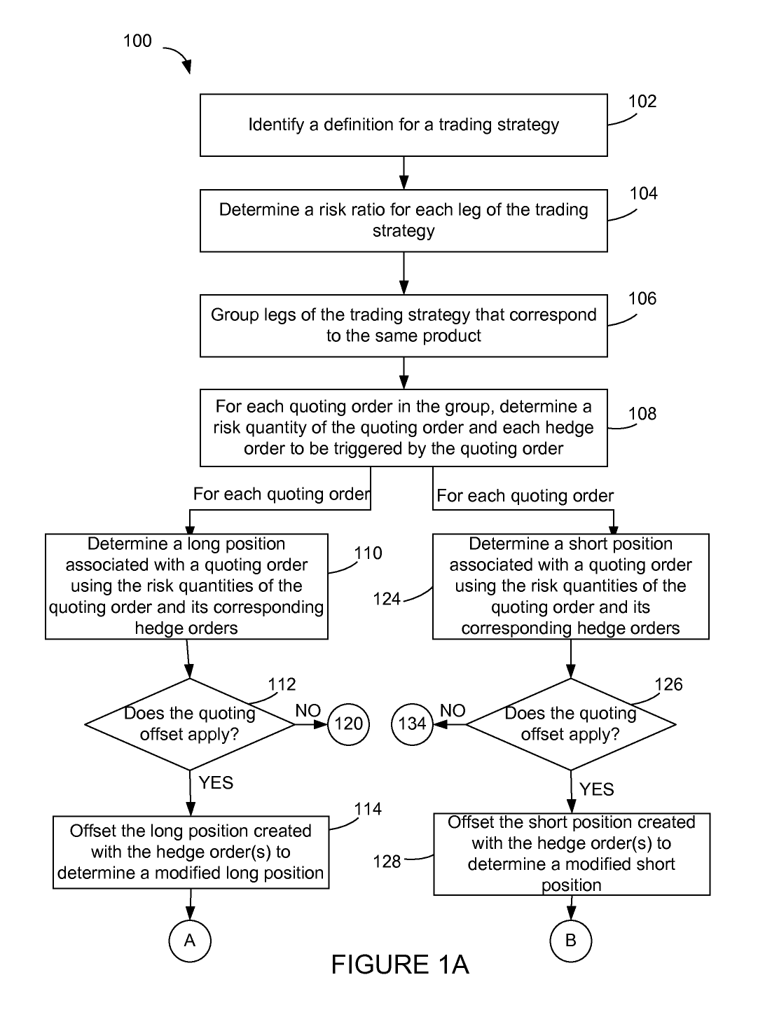

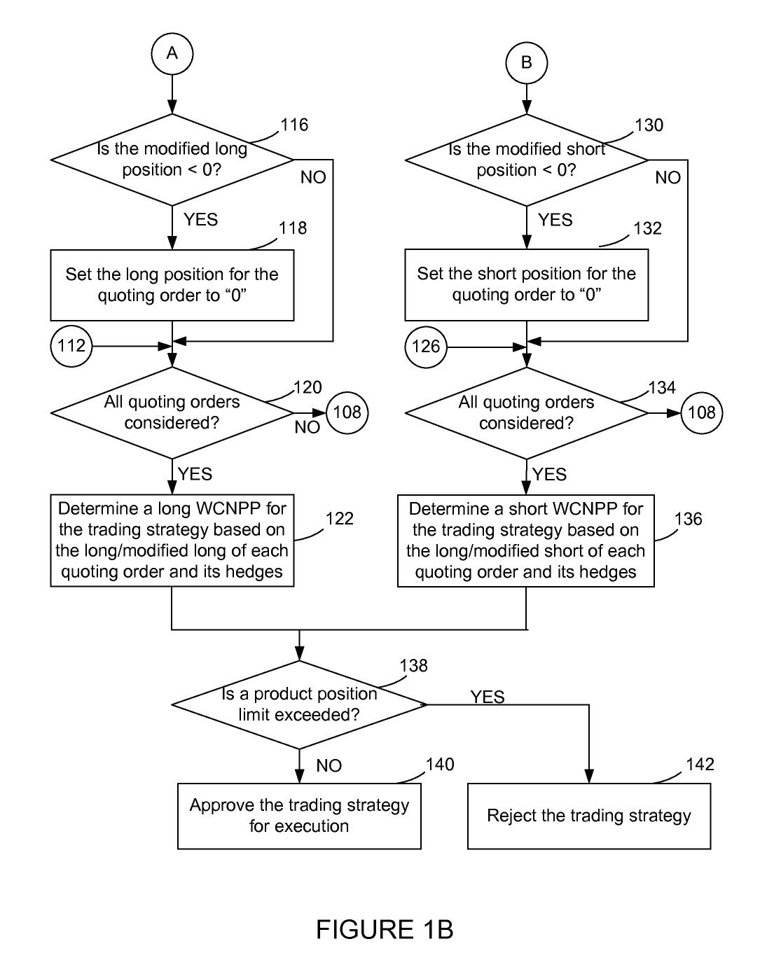

FIGS. 1A and 1B illustrate a flowchart 100 of a method for WCNPP calculations for a trading strategy according to certain embodiments.

It should be understood that each block in this and each subsequent flow diagrams may represent a module, segment or portion of code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of present invention.

Referring to FIG. 1A, at step 102, a definition of a trading strategy is identified. A definition of a trading strategy may represent one or more rules for making trading decisions. For example, a trading strategy may be defined to include a number of legs, with all or some of the legs identified as quoting legs. The definition of the trading strategy may also identify a tradeable object to be bought or sold with respect to each leg, as well as a ratio, such as a spread ratio, to be used in relation to the number of legs of the trading strategy. Additionally, the definition may include a desired quantity to be bought or sold in relation to the trading strategy. Further, the definition may include when hedge orders are to be sent to the market. For example, the hedge order may be sent upon detecting a quantity of the quoting order getting partially or fully filled. It should be understood that risk calculations described herein are not limited to any specific trading strategy, and that the trading strategies described herein are meant to illustrate various embodiments of risk calculations and management.

At step 104, a risk ratio is determined for each leg of the trading strategy. According to an example embodiment, if the trading strategy is a spread having each leg defined to buy or sell an individual futures contract, the risk ratio of each leg may be set to the spread ratio corresponding to each leg, e.g., the quantity of the leg in relation to other legs. According to another example embodiment, the risk ratio may be different than the spread ratio. For example, if a leg includes a two-leg exchange-provided spread with a spread ratio of “1” and “−1” and both legs include contracts of the same product, the risk ratio to be used for the leg may be set to “0,” as both legs of the exchange-provided spread cancel each other at the product level. According to another example, if a leg of a trading strategy includes a pack order, e.g., buying futures contracts in four consecutive months, and the leg has a spread ratio of “1”, the risk ratio for the leg may be set to “4” as there are four buy orders in the leg.

At step 106, all legs of the trading strategy that correspond to the same product are grouped for WCNPP calculations. For example, a trading strategy may involve buying and selling contracts having different expiration dates, where both contracts correspond to the same product, such as, for example, ES JAN11 and ES DEC11. In such an embodiment, a leg corresponding to ES JAN11 may be grouped with a leg corresponding to ES DEC11. According to one embodiment, if the legs include contracts corresponding to the same products, the legs may be grouped irrespective of whether the individual contracts are offered at the same or different exchanges. According to another example embodiment, the system may only group legs corresponding to the same product if the underlying contracts are offered at the same exchange.

It should be understood that the trading strategy could involve trading more than one product. In such an embodiment, more than one grouping of legs could be performed for each product of the trading strategy, and the steps of the method 100 described below would be repeated for each product of the trading strategy.

At step 108, for each quoting order in the group, a risk quantity is determined for a quoting order and each hedge order that is triggered by the quoting order. According to an example embodiment, the risk quantities for the quoting order and the hedge order(s) may be calculated based on a desired quantity specified for the trading strategy and the risk ratios corresponding to the legs. The risk quantity values for each quoting order for the same product may be received and/or identified by the risk check application by getting the values from a computing device configured to compute the quantity values or by reading a data structure with the values stored therein, for example.

For example, if a desired order quantity of a trading strategy is “1,” and the trading strategy includes buying “10” of leg 1 and selling “15” of leg 2, where both legs correspond to the same product and leg 1 is being quoted, then the buy risk order quantity of “10” is identified for a quoting order of leg 1, and the sell risk order quantity of “15” is identified for a hedge order of leg 2, according to block 108.

At step 110, a long position is determined in association with each quoting order of the trading strategy based on the risk quantities of the quoting order and its corresponding buy hedge order(s) that will be placed in other legs of the trading strategy when the quoting order is filled. Using the above example, a long position of “15” may be identified based on the buy risk order quantity identified for the quoting order of leg 1.

At step 112, it is determined if the quoting order offsets the long position created with the risk quantities of the hedge orders to be triggered by the quoting order. As used herein, if a quoting order is a sell, its risk quantity may offset the long position created by the hedge orders to buy that are triggered when the quoting order is filled. Using the example above, the long position of “10” is created by the quoting order, thus, no offset applies. If no offset applies, the method 100 continues at step 120.

At step 114, if the order quantity of the quoting order offsets the long position created by its corresponding hedge orders, a modified long position is determined by offsetting the long position with the risk quantity of the quoting order. At step 116, it is determined if the modified long position is less than “0,” and thus, does not contribute to the long position. If so, at step 118, the long position for the quoting order and its hedge order(s) is set to “0” for WCNPP calculations.

At step 120, it is determined if all quoting orders and their corresponding hedge orders have been evaluated in relation to the trading strategy. If not, the method 100 continues at 108. If all quoting orders and their corresponding hedge orders have been evaluated, at step 122, a long WCNPP is determined for the trading strategy based on the long position determined in relation to each quoting order and its hedge orders. According to an example embodiment, the long/modified long positions calculated for the quoting orders and their corresponding hedge orders may be added to determine the long WCNPP for the trading strategy.

Referring back to step 108, at step 124, a short position is determined for each quoting order of the trading strategy based on the risk quantities of the quoting order and its corresponding hedge order(s). Referring to the example above, the short position of “15” may be identified based on the sell risk order quantity identified for the hedge order of leg 2.

At step 126, it is determined if the quoting order offsets the short position created with the risk quantities of the hedge orders to be triggered by the quoting order. As used herein, if a quoting order is a buy, the risk quantity of the quoting order may offset the short position created by the hedge order(s) to be triggered by the quoting order. Referring again to the example above, the short position of “15” is created by the hedge order that is triggered with the quoting order that creates the long position of “10.” Thus, the short position of “15” corresponding to the hedge order may be offset with the long position of “10” corresponding to the quoting order. If it is determined that the quoting order offset does not apply, the method 100 continues at step 134.

If it is determined that the quoting order offsets the short position, at step 128, a modified short position is determined by offsetting the calculated short position associated with the hedge order(s) with the risk quantity of the corresponding quoting order. Using the example above, the modified short position is “5,” as the short position of “15” is offset with the long position of “10” corresponding to the quoting order.

At step 130, it is determined if the modified short position is less than “0.” If so, at step 132, the short position determined in relation to the quoting order and its corresponding hedge order(s) is set to “0” for WCNPP calculations. Referring back to the example above and assuming that the long position created by the quoting order was “20,” the modified short position would result in “−5,” thus not contributing to the short position for the worst case position calculations.

At step 134, it is determined if all quoting orders and their corresponding hedge orders have been evaluated. If not, the method continues at 108. If all quoting orders have been evaluated, at step 136, a short WCNPP is determined for the trading strategy based on the short/modified short position determined for each quoting order and its corresponding hedge orders. According to an example embodiment, the short/modified short position calculated based on each quoting order and its corresponding hedge orders may be added to determine the short WCNPP.

According to an example embodiment, the following formulas may be used to calculate a Long WCNPP and a Short WCNPP:

Long WCNPP for Each Quoting Order and its Corresponding Hedge Orders:

MAX(Long Quoting Quantity+Long Hedge Quantity−Short Quoting Quantity,Long Quoting Quantity), where each quantity value corresponds to the same product.

Long WCNPP for a Trading Strategy Order:

ΣLong WCNPP for each quoting order and its corresponding hedge orders.

Short WCNPP for Each Quoting Order and its Corresponding Hedge Orders:

MAX(Short Quoting Quantity+Short Hedge Quantity−Long Quoting Quantity,Short Quoting Quantity, where each quantity value corresponds to the same product.

Short WCNPP for a Trading Strategy Order:

ΣShort WCNPP for each quoting order and its corresponding hedge orders.

Once the Long WCNPP and the Short WCNPP are determined, the overall WCNPP may be determined for the trading strategy order using the following formula:

Overall WCNPP for a Single Strategy Order:

MAX(Long WCNPP,Short WCNPP).

At step 138, it is determined if a WCNPP limit would be exceeded if the trading strategy was executed. According to an example embodiment, the overall WCNPP at the product level may be determined and compared to its respective WCNPP limit. The overall WCNPP at the product level may be computed by combining the WCNPP computed for the order of the trading strategy with the total working quantity of buy and sell orders in the product, and the current position being held in relation to the product. The following formulas may be used to calculate the overall Long WCNPP, the overall Short WCNPP, and the overall WCNPP. It should be assumed that the formulas below include quantities of orders which are about to be placed for the trading strategy or are in the working category.

Product Level Long WCNPP:

LWCNPP=SUM(LWCNPP for every trading strategy order)+Working Buys+Current Position.

Product Level Short WCNPP:

SWCNPP=SUM(SWCNPP for every trading strategy order)+Working Sells−Current Position.

Overall Product Level WCNPP:

Overall WCNPP=MAX(LWCNPP,SWCNPP).

According to the example embodiment described above, the comparison is made between the overall WCNPP for the product level considering all orders that have been or will be entered to buy or sell the product. However, it should be understood that the comparison may be made at any other level, such as at the trading strategy order level when a long/short WCNPP is computed for the trading strategy order. In such an embodiment, a long/short WCNPP may be compared to a preset product limit defined for use in relation to the trading strategy. Alternatively, the overall WCNPP determined for the trading strategy order may be compared to a predetermined limit.

At step 140, if the product position is not exceeded, the trading strategy is approved for execution, and one or more quoting orders for the trading strategy may be placed in the exchange order book at the electronic exchange.

At step 142, if the product position is exceeded, the trading strategy is not approved for execution. When the trading strategy is rejected, no orders corresponding to the trading strategy are placed at the electronic exchange.

A. WCNPP Examples

As explained above, a trader may define a trading strategy that involves placing at least two orders. In certain embodiments, the trading strategy is a spread trading strategy, in which a quoting order is placed for a first tradeable object and a hedge order is placed for a second tradeable object when the quoting order is filled. In other words, a quoting order is sent to a leg of the spread to work a bid or offer to achieve a desired spread price. When the quoting order is filled, an offsetting hedge order is sent to another leg to complete the spread at the desired spread price.

A trader may utilize a trading tool to trade according to a trading strategy. For example, the trading tool, Autospreader™ provided by Trading Technologies, Inc. of Chicago, Ill., provides a software tool for trading spreads. Autospreader also provides a mechanism for defining a trading strategy. Defining a trading strategy using Auto spreader may include entering a spread ratio, spread multiplier, tolerance parameters (e.g., slop), and other parameters. Components of a tool like Auto spreader may be implemented on a client side, a server side, or a combination of the client and server sides.

(i) Two-Legged Spread, Two Quoting

For example, assume that a trader configures a two-legged spread. That is, the spread is between two tradeable objects, and each tradeable object represents one leg of the spread. Assume also that a spread ratio is set to “1” and “−1” for the two legs of the spread, and a desired spread quantity is “1.” The trader also wishes to quote in both legs of the spread. Assume also that the tradeable objects are the same product (“Product A”), with one leg corresponding to “MAR” contract, and the second leg corresponding to “JUN” contract. With the trading strategy defined, the trader may begin initiating orders. According to the embodiments described herein, before any orders are sent to an electronic exchange for the trading strategy, the risk check is applied to determine the WCNPP for the trading strategy. The WCNPP for the trading strategy may then be used to determine the overall WCNPP across all orders/trading strategies of the trader, and the overall WCNPP may be compared to a preset risk limit associated with the overall WCNPP.

In certain embodiments, a trader may specify a desired spread price and a desired spread quantity. Responsively, a tool like Autospreader may compute an order quantity and a price to quote for each leg. The order quantity and the price at which a hedge order is entered may also be computed using the spread ratio, the desired order quantity and the desired spread price.

As explained above, the risk application may determine a risk ratio in relation to each leg of the trading strategy. Using the spread ratio and the tradeable object that is traded in each leg of the spread, the risk ratio for each leg of the trading strategy is “1.” The risk quantity of each leg is also “1” based on the risk ratio and the desired spread quantity. As shown in Table 1 below, and assuming that both legs are being quoted, the risk check identifies a buy risk quantity of “1” for “MAR” quoting order and a sell risk quantity of “1” for “JUN” hedge order to be triggered by “MAR” quoting order. Thus, the total long position and the total short position created by “MAR” quoting order and its hedge order are “1” and “1,” respectively. Similarly, for “JUN” quoting order, the total long position of “1” is created by “MAR” buy hedge order, and the total short position of “1” is created by “JUN” sell quoting order.

According to the example embodiment for calculating the WCNPP in relation to the trading strategy having legs in the same product, the short position calculated in relation to “MAR” quoting order may be offset by “MAR” quoting order. In other words, the long position of “1” created by the quoting order may be used to offset the short position of “1” created by the hedge order. Based on the offset, a modified short position for “MAR” quoting order and its corresponding hedge orders is “0.” Similarly, the long position of “1” calculated in relation to “JUN” quoting order based on the hedge order quantity may be offset by the short position of “1” created by the quoting order in “JUN.” Based on the offset, a modified long position determined in relation to “JUN” quoting order is “0.”

TABLE 1

| | “MAR” Quoting Order and | | “JUN” Quoting Order and | |
|---|---|---|---|---|
| PRODUCT | Its Corresponding Hedges | | ItsCorresponding Hedges | |
| A | Long | Short | Long | Short |
| MAR | 1Q | | 1H | |
| JUN | | 1H | | 1Q |
| Total | 1 | 1 | 1 | 1 |
| Offset | | −1 | −1 | |
| Modified | 1 | 0 | 0 | 1 |
| Total | | | | |

Using the values shown in Table 1, the long WCNPP for the trading strategy is “1” (“1” calculated in relation to “MAR” quoting order plus “0” calculated in relation to “JUN” quoting order), rather than “2,” as it would have been if the conventional risk calculation methods were used. Similarly, the short WCNPP for the trading strategy order is “1” rather than “2.”

The long WCNPP may be computed for each quoting order and its corresponding hedge orders that are triggered in other legs of the trading strategy upon a fill of the quoting order using the equations described above:

Long WCNPP for MAR Quoting Order:

MAX(Long Quoting Quantity+Long Hedge Quantity−Short Quoting Quantity,Long Quoting Quantity)=MAX(1+0−0,1)=Long 1

Long WCNPP for JUN Quoting Order:

MAX(Long Quoting Quantity+Long Hedge Quantity−Short Quoting Quantity,Long Quoting Quantity)=MAX(0+1−1,0)=Long 0

Short WCNPP for MAR Quoting Order

MAX(Short Quoting Quantity+Short Hedge Quantity−Long Quoting Quantity,Short Quoting Quantity)=MAX(0+1−1,0)=Short 0

Short WCNPP for JUN Quoting Order:

MAX(Short Quoting Quantity+Short Hedge Quantity−Long Quoting Quantity,Short Quoting Quantity)=MAX(1+0−0,1)=Short 1

Overall WCNPP for the Trading Strategy:

WCNPP=MAX(LWCNPP,SWCNPP)=MAX(1,1)=1

Once the overall WCNPP is calculated for the trading strategy, the calculated WCNPP may be used by the risk application to determine if the trading strategy should be approved for execution. As explained above, the risk application may calculate the overall WCNPP using the WCNPP calculated for the trading strategy as well as WCNPP calculated for the trader's working orders and positions being held by the trader in the same product. The overall WCNPP may then be compared to a preset WCNPP limit. If the limit is not exceeded, the trading strategy may be approved for execution. Otherwise, the trading strategy may be rejected.

(ii) Three-Legged Spread, Three Legs are Quoting

According to another example, assume that a trader configures a three-legged spread quoting all three legs. That is, the spread is between three tradeable objects, and each tradeable object represents one leg of the spread. Assume also that the tradeable objects correspond to the same product (“Product A”), with the first leg corresponding to “MAR” contract, the second leg corresponding to “JUN” contract, and the third leg corresponding to “SEP” contract. Assume also that a spread ratio is “1,” “−2,” and “1,” and a desired spread quantity is “1.” Based on the spread ratio and the tradeable object traded in each leg of the spread, a risk ratio is the same as the spread ratio.

As shown in Table 2, the risk check identifies the total long quantity of “2” and the total short quantity of “2” for each quoting order and its corresponding hedge order to be triggered when the quoting order is filled. For example, the total long quantity of “2” is created in relation to “MAR” quoting order based on a buy quoting order of “1” in “MAR” leg and a buy hedge order of “1” in “SEP” leg that will be triggered when the quoting order is filled. Then, the total short quantity of “2” for “MAR” quoting order is created by a sell hedge order of “2” to be entered in “JUN” leg when the quoting order is filled.

According to the example embodiment, the risk quantity of quoting orders in each leg is used to offset the total long or short position determined in relation to each quoting order and its corresponding hedges. As shown in Table 2, the total short position determined based on hedge orders of “MAR” quoting order is offset by “1” using the buy quoting order in “MAR” leg. Similarly, the total long position calculated based on hedge orders of “JUN” quoting order is offset by the sell quoting order in “JUN” leg. Then, the total short position determined based on hedge orders of “SEP” quoting order is offset by the buy quoting order in “SEP” leg. Based on the offsets, the modified short positions for “MAR” quoting order and its hedges and for “SEP” quoting order and its hedges are “1,” Then, the modified long position in “JUN” quoting order and its hedge orders is “0.”

Using the values shown in Table 2, the long WCNPPs for the trading strategy is “4,” (“2+0+2”), and the short WCNPP is “4” (“1+2+1”).

TABLE 2

| | “MARCH” | | “JUNE” | | “SEPTEMBER” | |
|---|---|---|---|---|---|---|
| | Quoting Order | | Quoting Order | | Quoting Order | |
| | and its | | and its | | and its | |
| | Hedge Orders | | Hedge Orders | | Hedge Orders | |
| PRODUCT A | Long | Short | Long | Short | Long | Short |
| MARCH | 1Q | | 1H | | 1H | |
| JUNE | | 2H | | 2Q | | 2H |
| SEPTEMBER | 1H | | 1H | | 1Q | |
| Total | 2 | 2 | 2 | 2 | 2 | 2 |
| Offset | | −1 | −2 | | | −1 |
| Modified Total | 2 | 1 | 0 | 2 | 2 | 1 |

As shown in relation to the preceding example, the long and short WCNPP may be calculated based on the equations described above. Based on the long and short WCNPP determined for the trading strategy order, the overall WCNPP for the order is “4.” (MAX (LWCNPP, SWCNPP)=MAX (4,4)=4).

(iii) Spread Order Including an Exchange-Provided Calendar Spread

According to another example, assume that a trader configures a three-legged spread. That is, the spread is between an exchange provided calendar spread “(MAR-JUN),” “MAR” contract, and “JUN” contract of the same product (“Product A”). Assume also that a spread ratio is “1,” “−2,” and “1,” and a desired spread quantity is “2.” Based on the spread ratio and the type of tradeable object in each leg of the spread, a risk ratio is determined. The risk ratio for “MAR-JUN” leg is “0” as the legs of the exchange-provided spread cancel each other for the product-level risk analysis as they are both for the same product, both having equal spread ratio, and one being a buy and another being a sell. Then, the risk ratio for “MAR” leg is “−2,” and the risk ratio for “JUN” is “1.” Based on the desired order quantity of the spread and the risk ratio, the risk quantities of the three legs are “0,” “4” short, and “2” long.

As shown in Table 3, the risk check application identifies the total long quantity of “2” and the total short quantity of “4” in relation to “MAR-JUN” quoting order and its corresponding hedge orders, the total long quantity of “2” and the total short quantity of “4” for “MAR” quoting order and its corresponding hedge orders, and the total long quantity of “2” and the total short quantity of “4” for “JUN” quoting order and its corresponding hedge orders. For example, as shown in Table 3, the total long quantity of “2” for “MAR-JUN” quoting order and its hedges is created by a buy quoting order having a risk ratio of “0” in “MAR-JUN” leg and a buy hedge order of “2” in “JUN” leg. Then, the total short quantity of “4” for “MAR-JUN” quoted leg is created by a sell hedge order of “4” in “MAR” leg.

Similarly to the examples described above, the risk quantity of the quoting order is used to offset the total long or short position determined for each quoting order and its hedges. As shown in Table 3, there is no offset applied to the short position created by a hedge order in “MAR” as the risk quantity for “MAR-JUN” quoting order is “0.” Then, in relation to “MAR” quoting order and its hedges, the long position is offset by “4” using the sell quoting order in “MAR” leg. Based on the offset, the modified long position is “−2,” and thus, the modified total long position for “MAR” quoting order and its hedges is set to “0.” Similarly, the total short position determined for “JUN” quoting order and its hedges is offset by the buy quoting order in “JUN” leg. Based on the offset, the modified total short position is “2” for “JUN” quoting order and its corresponding hedges.

Using the values shown in Table 3, the long WCNPP for the trading strategy order is “4,” and the short WCNPP for the order is “10.”

TABLE 3

| | “MARCH-JUNE” | | “MARCH” | | “JUNE” | |
|---|---|---|---|---|---|---|
| | Quoting Order | | Quoting Order | | Quoting Order | |
| | and Its | | and Its | | and Its | |
| | Corresponding | | Corresponding | | Corresponding | |
| | Hedges | | Hedges | | Hedges | |
| PRODUCT A | Long | Short | Long | Short | Long | Short |
| MARCH-JUNE | 0Q | | 0H | | 0H | |
| MARCH | | 4H | | 4Q | | 4H |
| JUNE | 2H | | 2H | | 2Q | |
| Total | 2 | 4 | 2 | 4 | 2 | 4 |
| Offset | | −0 | −4 | | | −2 |
| Modified Total | 2 | 4 | −2 < 0 →0 | 4 | 2 | 2 |

Based on the long and short WCNPP determined for the trading strategy order, the overall WCNPP for the order is “10.” (MAX (LWCNPP, SWCNPP)=MAX (4,10)=10).

As explained above, the long and short WCNPP for the trading strategy order may also be computed using the equation described above.

(iv) Spread Order Including a Pack

According to yet another example, assume that a trader configures a five-legged spread including a pack. That is, the spread is between a pack “(+1MAR+1JUN+1SEP+1DEC), “MAR” contract, “JUN” contract, and “SEP” contract, and “DEC” contract of the same product (“Product A”). Assume also that the spread ratio is “3,” “−1,” “−3,” “−5,” and “−1” with the first three legs being quoted, and a desired order quantity for the spread set to “1.” The risk ratio for “PACK” leg is “12” (“4”×“3”) as the leg includes four contracts to buy and the spread ratio is “3” for the “PACK” leg. The risk ratio for each remaining leg corresponds to the spread ratio of each leg. Because the desired order quantity for the spread is “1,” the risk quantity of each leg is equal to each leg's risk ratio.

As shown in Table 4, the risk check application identifies the total long quantity of “13” and the total short quantity of “9” for “PACK” quoting order and its hedge orders. Then, the total long quantity of “13” and the total short quantity of “9” are determined for “MAR” and “JUN” quoting orders and their corresponding hedge orders. For example, as shown in Table 4, the total short quantity of “9” for “PACK” quoting order and its hedges is created by a sell “JUN” hedge order, a sell “SEP” hedge order, and a sell “DEC” hedge order. The total short quantity for the “PACK” is then offset by a buy “PACK” quoting order. However, because the offset short position results in a value less than “0,” the modified total short position is set to “0” for “PACK” quoting order and its hedges. Table 4 illustrates the modified total positions for each quoting order and its corresponding hedge orders of the spread order. Based on the values in Table 4, the long WCNPP is “36,” and the short WCNPP is “17.”

TABLE 4

| | “PACK” | | “MARCH” | | “JUNE” | |
|---|---|---|---|---|---|---|
| | Quoting Order | | Quoting Order | | Quoting Order | |
| | and Its | | and Its | | and Its | |
| | Corresponding | | Corresponding | | Corresponding | |
| | Hedges | | Hedges | | Hedges | |
| PRODUCT A | Long | Short | Long | Short | Long | Short |
| MARCH-JUNE | 12Q | | 12H | | 12H | |
| MARCH | 1H | | 1Q | | 1H | |
| JUNE | | 3H | | 3H | | 3Q |
| SEPTEMBER | | 5H | | 5H | | 5H |
| DECEMBER | | 1H | | 1H | | 1H |
| Total | 13 | 9 | 13 | 9 | 13 | 9 |
| Offset | | −12 | | −1 | −3 | |
| Modified Total | 13 | −3 < 0→0 | 13 | 8 | 10 | 9 |

Based on the long and short WCNPP determined for the trading strategy order, the overall WCNPP for the order is “36.” (MAX (LWCNPP, SWCNPP)=MAX (36,17)=36).

(v) Spread Orders with Partially Disclosed Quantities

According to yet another embodiment, a user may specify a total order quantity for a trading strategy, but only a portion of the total order quantity may be submitted, or disclosed, to the market at a time. When the disclosed order quantity for the trading strategy is executed, a new order with a new disclosed quantity for the trading strategy may be generated. The process may continue until the total order quantity for the trading strategy is executed or until a predefined condition, such as an order cancelation, is detected. It should be understood that a disclosed quantity as well as a price level for each disclosed order of the trading strategy may be user defined or may be determined based on a formula.

Assume that a trader configures a 10-lot two-legged spread order between “MAR” contract and “JUN” contract corresponding to “Product A,” with both legs being quoted. Assume also that the spread has a spread ratio of “5” and “−3,” and a disclosed quantity of the spread order is “1.” Based on the disclosed quantity and a risk ratio, a risk quantity for each spread leg of the disclosed spread order is the same as the spread ratio.

According to Table 5, the risk check identifies the quoting quantities of “+5” for “MAR” and “−3” for “JUN” for the disclosed spread order quantity of “1.” Then, the hedge quantities for “MAR” and “JUN” are “+5” and “−3” respectively. The modified hedge order quantities are “2” and “0” based on the offset applied to each respective order.

TABLE 5

| | “MAR” Quoting Order and | | “JUN” Quoting Order and | |
|---|---|---|---|---|
| PRODUCT | Its Corresponding Hedges | | Its Corresponding Hedges | |
| A | Long | Short | Long | Short |
| MAR | 5Q | | 5H | |
| JUN | | 3H | | 3Q |
| Total | 5 | 3 | 5 | 3 |
| Offset | | −5 | −3 | |
| Modified | 5 | −2 < 0→0 | 2 | 3 |
| Total | | | | |

Using the values shown in Table 5, the long WCNPP for the disclosed order of the trading strategy is “7,” and the short WCNPP is “3.” In addition to considering the disclosed quantities, undisclosed quantities of “45” in “MAR” and “27” in “JUN” are also considered to determine the total WCNPP for the full order of the trading strategy. According to an example embodiment, the WCNPP may be calculated for the undisclosed quantities. The calculated value may then be added to the long or short WCNPP of the disclosed order, depending on whether the calculated value corresponds to the long or short position. In the example provided herein, the WCNPP for the undisclosed quantities is “+18” (45L−27S). Thus, the long WCNPP for the order of the trading strategy is “25” (7+18), and the short WCNPP is “3.”

### II. Worst Case Contract Position Calculations

When the WCCP position is calculated for an order of a trading strategy that includes the same contract in more than one leg, the interaction between the legs corresponding to the same contract may cancel out some of the risk. The methods described herein for calculating the WCCP may be used, for example, in relation to a spread order that involves buying or selling a contract in one leg and an exchange provided spread in another leg, where the exchange-provided spread includes the same contract in one of its legs.

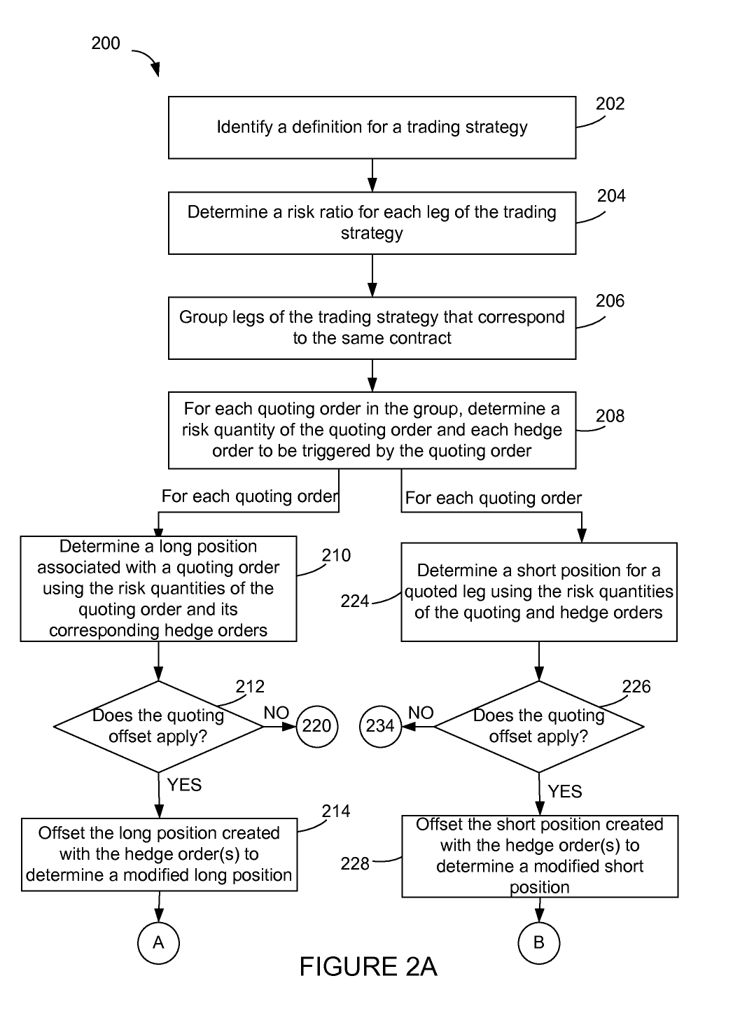

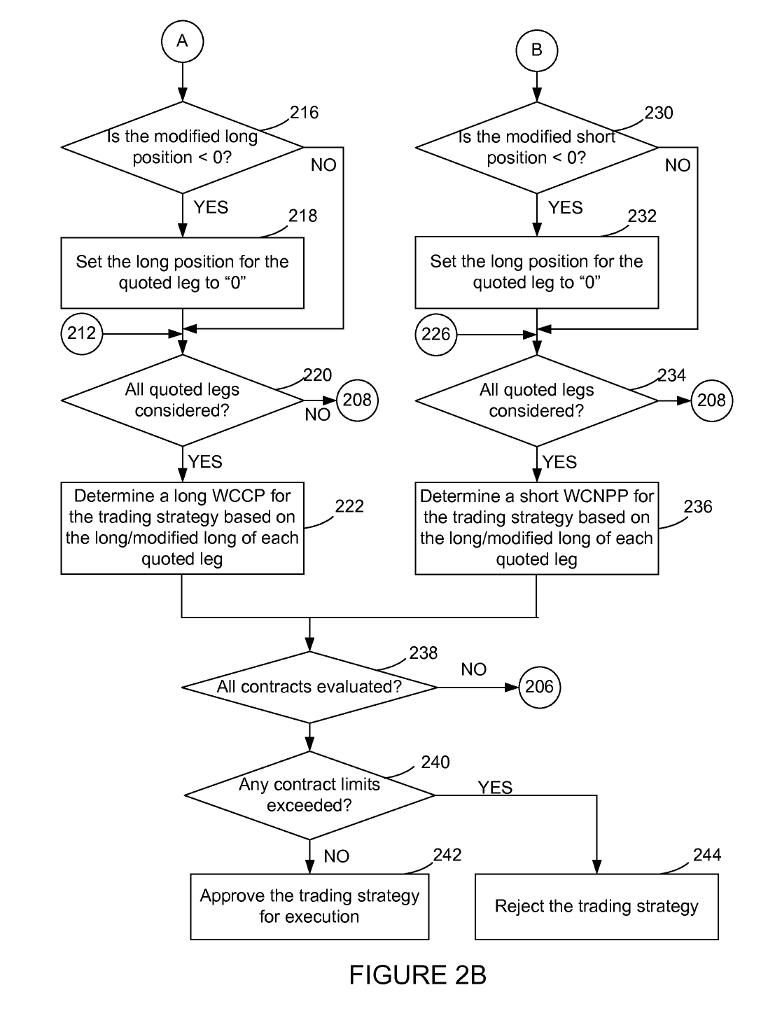

FIGS. 2A and 2B illustrate a flowchart 200 of a method for calculating the WCCP for a trading strategy according to certain embodiments.

At step 202 in FIG. 2A, a definition of a trading strategy is identified. As explained in relation to FIGS. 1A and 1B, the trading strategy may be defined to include a number of legs to buy or sell various tradeable objects, with some or all of the legs identified as quoting legs, and a ratio, such as a spread ratio, to be used in relation to the legs. A desired quantity for the trading strategy is defined as well. According to an example method described herein, it is assumed that the trading strategy includes the same contract in two or more legs, such as when one leg is defined as an exchange provided spread that includes the same contract as another leg of the trading strategy.

At step 204, a risk ratio is determined for each leg of the trading strategy. The risk ratio for each leg may be determined using the methods described above.

At step 206, all legs of the trading strategy that correspond to the same contract are grouped for WCCP calculations. For example, if a trading strategy includes buying an exchange provided spread, such as, for example, “ES JAN11-ES DEC11,” and selling “ES JAN11” contract, “ES JAN11” may be identified as the common contract in the first leg of the trading strategy and the second leg of the trading strategy. Thus, the two legs may be grouped for the WCCP calculations.

At step 208, for each quoting order in the group, a risk quantity is determined for a quoting order and each hedge order that is triggered by the quoting order. The risk quantities may be determined using the methods described above.

At step 210, a long position is determined for a quoting order and its corresponding hedge orders using the risk quantities of the quoting order and its hedge orders in the same contract. As explained above, the risk quantities of the leg's quoting order to buy and its buy hedge order(s) may be used to determine the long position in relation to the quoting order and its hedges.

At step 212, it is determined if the quoting order offsets the long position created with the risk quantities of the hedge order(s) to be triggered by the quoting order in the same contract. As used herein, if a quoting order is a sell, its risk quantity may offset the long position created by the hedge orders of the quoting order.

At step 214, if the order quantity of the quoting order offsets the long position created by the hedge orders, a modified long position is determined for the leg by offsetting the calculated long position with the risk quantity of the quoting order. At step 216, it is determined if the modified long position is less than “0.” If so, at step 218, the long position for the quoted leg is set to “0” for the WCCP calculations.

At step 220, it is determined if all grouped quoting orders of the trading strategy have been evaluated. If not, the method 200 continues at 208. If all quoting orders have been evaluated, at step 222, a long WCCP is determined for the trading strategy based on the long/modified long positions determined for each quoting orders and their corresponding hedge orders.

Referring back to step 208, at step 224, a short position is determined in relation to each quoting order of the trading strategy based on the risk quantities of each quoting order and its corresponding hedge orders that contribute to the short position and that will be placed in other legs of the trading strategy when the quoting order is filled.

At step 226, it is determined if the quoting order offsets the short position created with the risk quantities of the hedge orders to be triggered by the quoting order. As used herein, if a quoting order in a leg is a buy, the risk quantity of the quoting order may offset the short position created by the hedge order of the quoting order.

If it is determined that the quoting order offsets the short position for the leg, at step 228, a modified short position is determined for the leg by offsetting the leg's short position with the risk quantity of the quoting order. At step 230, it is determined if the modified short position is less than “0.” If so, at step 232, the short position determined is relation to the quoting order and its hedge orders is set to “0” for WCCP calculations.

At step 234, it is determined if all grouped quoting orders have been evaluated. If not, the method 200 continues at 208. If all quoting orders with their corresponding hedges have been evaluated, at step 236, a short WCCP is determined for the trading strategy based on the short/modified short position determined for each quoted leg in the group. According to an example embodiment, the short/modified short position calculated in relation to each quoting order may be added to determine the short WCCP for the order of the trading strategy.

According to an example embodiment, the following formulas may be used to calculate a Long WCCP and a Short WCCP:

Long WCCP for Each Quoting Order and its Corresponding Orders:

MAX(Long Quoting Quantity+Long Hedge Quantity−Short Quoting Quantity,Long Quoting Quantity), where each quantity value corresponds to the same contract.

Long WCNPP for a Trading Strategy Order:

ΣLong WCNPP for each quoting order and its corresponding hedges.

Short WCCP for Each Quoting Order and its Corresponding Hedges:

MAX(Short Quoting Quantity+Short Hedge Quantity−Long Quoting Quantity,Short Quoting Quantity), where each quantity value corresponds to the same contract.

Short WCNPP for a Trading Strategy Order:

ΣShort WCNPP for each quoting order and its corresponding hedges.

Once the Long WCCP and the Short WCCP are determined, the WCCP may be determined for the trading strategy order using the following formula:

Overall WCCPP for a Single Strategy Order:

MAX(Long WCCP,Short WCCP).

At step 238, it is determined if all contracts of the trading strategy have been evaluated. If not all contracts have been evaluated, the method continues at step 206. Otherwise, at step 240, it is determined if any WCCP limit associated with each contract of the trading strategy would be exceeded if the trading strategy was executed. According to an example embodiment, the overall WCCP at the contract level may be determined and compared to its respective WCCP limit. The overall WCCP at the contract level may be computed by combining the WCCP computed for the order of the trading strategy with the total working quantity of buy and sell orders in the same contract, and the current position being held in relation to the contract. The following formulas may be used to calculate the overall Long WCCP, the overall Short WCCP, and the overall WCCP. It should be assumed that the formulas below include quantities of orders which are about to be placed for the trading strategy or in the working category.

Long WCCP Integrating Existing Positions and Working Orders:

Long WCCP=MAX(Current Contract Position+Working Contract Buys+LWCCP for every trading strategy,0)

Short WCCP Integrating Existing Positions and Working Orders:

Short WCCP=MIN(Current Contract Position+Working Contract Sells+SWCCP for every trading strategy,0)

Overall Contract Level WCCP:

Overall WCCP=MAX(LWCCP,SWCCP).

According to the example embodiment described above, the comparison is made between the overall WCCP for the contract level considering all orders that have been or will be entered to buy or sell the contract. However, it should be understood that the comparison may be made at any other level, such as at the trading strategy order level when a long/short WCCP is computed for the trading strategy order. In such an embodiment, a long/short WCCP may be compared to a preset contract limit defined for use in relation to the trading strategy.

At step 242, if the contract position is not exceeded, the trading strategy is approved for execution, and one or more quoting orders for the trading strategy may be placed in the exchange order book at the electronic exchange. At step 244, the trading strategy is not approved for execution. When the trading strategy is not approved for execution, no orders corresponding to the trading strategy are placed at the electronic exchange.

A. Worst Case Contract Position Examples

(i) Spread Order Including an Exchange Provided Spread

According to one example, assume that a trader configures a three-legged spread. That is, the spread is between an exchange provided calendar spread “(MAR x-JUN),” “MAR” contract, and “JUN” contract of the same product (“Product A”). Assume also that the spread ratio is “3,” “−1,” and “1,” and the first and third legs are quoted.

First, the risk check may group the first two legs for WCCP calculations for “MAR” contract, and the first and third legs for WCCP calculations for “JUN” contract. The quoting and hedge orders in each leg may then be used to determine a long WCCP and a short WCCP for each contract. Assuming that a desired order quantity for the trading strategy is “1,” the risk quantities for each leg are “3” long, “1” short, and “1” long.

As shown in Table 6, the risk check identifies “JUN” contract in “MAR-JUN” leg and “JUN” leg as the common contract. For example, when MAR-JUN leg is quoted, the quoting order creates a short position of “3” for “JUN” in “MAR-JUN” quoted leg, and a long position of “1” for “JUN” in “JUN” leg. Similarly, when “JUN” leg is quoted, a long position of “1” is created for “JUN” by “JUN” quoted leg and a short position of “3” is created for “JUN” in “MAR-JUN” hedge leg. A total long and short positions are then computed for “JUN” in relation to each quoting order and its hedges. The calculated values may then be offset by the risk quantity of the quoting order. As shown in Table 6, Long WCCP and Short WCCP for “MAR” contract are “1” and “5” respectively.

TABLE 6

| | “MAR-JUN” Quoting Order | | “JUN” Quoting Order and | |
|---|---|---|---|---|
| | and its Hedge Orders, creating | | its Hedge Orders, creating | |
| JUN | positions in “JUN” | | positions in “JUN” | |
| Contract | Long | Short | Long | Short |
| MAR-JUN | | 3Q | | 3H |
| JUN | 1H | | 1Q | |
| Total | 1 | 3 | 1 | 3 |
| Offset | −3 | | | −1 |
| Modified | − 2 < 0→0 | 3 | 1 | 2 |
| Total | | | | |

Similar calculations may be performed for “MAR” contract. Table 7 illustrates risk quantities that are used in relation to each quoting order and its hedges to determine a Long WCCP and a Short WCCP for “MAR.” As shown in relation to “JUN” quoted leg, while the quoting order produces hedge orders in relation to “MAR” contract, the risk quantity associated with “JUN” quoting order is not used as an offset, as the quoting order is in a different contract. As shown in Table 7, a Long WCCP for “MAR” is “6,” and a Short WCCP for “MAR” is “1.”

TABLE 7

| | “MAR-JUN” Quoting Order | | “JUN” Quoting Order and | |
|---|---|---|---|---|
| | and its Hedge Orders, creating | | its Hedge Orders, creating | |
| MAR | positions in “MAR” | | positions in “MAR” | |
| Contract | Long | Short | Long | Short |
| MAR-JUN | 3Q | | 3H | |
| MAR | | 1H | | 1H |
| Total | 3 | 1 | 3 | 1 |
| Offset | | −3 | | |
| Modified | 3 | −2 < 0→0 | 3 | 1 |
| Total | | | | |

(ii) Spread Orders with Partially Disclosed Quantities

According to another embodiment, a user may specify a total order quantity for a trading strategy, but only a portion of the total order quantity may be submitted, or disclosed, to the market at a time. One such strategy was described above in relation to example (v) of Section I. The methods described herein for calculating Long WCCP and Short WCCP could be used in relation to such trading strategies as well.

Assume that a trader configures a 10-lot, two-legged spread order between an exchange-provided spread “MAR-JUN” and “MAR,” with both legs being quoted and all contracts corresponding to the same product. Assume also that the spread has a spread ratio of “5” and “−3,” and a disclosed quantity of each spread order set to “1.”

According to Table 8, the risk check identifies a Long WCCP of “7” and a Short WCCP of “3” for “MAR” contract. Similar calculations may be performed for “JUN,” and result in a Long WCCP of “0” and a Short WCCP of “10.”

TABLE 8

| | “MAR-JUN” Quoting Order | | “MAR” Quoting Order | |
|---|---|---|---|---|
| MAR | and its Hedge Orders | | and its Hedge Orders | |
| Contract | Long | Short | Long | Short |
| MAR-JUN | 5Q | | 5H | |
| MAR | | 3H | | 3Q |
| Total | 5 | 3 | 5 | 3 |
| Offset | | −5 | −3 | |
| Modified | 5 | −2 < 0→0 | 2 | 3 |
| Total | | | | |

In addition to considering the disclosed quantities for each contract, an undisclosed buy quantity of “45” may be identified for the quoting and hedge legs of “MAR-JUN,” and an undisclosed sell quantity of “27” may be identified for the quoting and hedge legs of “MAR.” The undisclosed quantities may then be used to determine the worst case position in relation to each contract. The calculated value may then be added to the long or short WCCP of the disclosed order corresponding to the same contract. In the example provided herein, the contract position for “MAR” is “36” long (45+45−27−27). Thus, the overall long WCCP for “MAR” is “43” (7+36).

III. WCCP/WCNPP with Existing Positions and Working Orders Example

As explained above, existing positions and working orders may be integrated into calculations of the overall WCCP and WCNPP. According to an example embodiment, assume that a trader holds a short position of “6” in “MAR” contract, and a long position of “8” in “JUN.” Also assume that the trader has a working order to sell “2” in “MAR” contract. The existing positions and working orders are shown in Table 9.

TABLE 9

| Product A | Positions | Orders |
|---|---|---|
| MAR | 6 Short | 2 Short |
| JUN | 8 Short | |

Additionally, assume that a trader configures a three legged spread. That is, the spread is between the exchange-provided spread “(MAR-JUN),” “MAR” contract, and “JUN” contract of the same product “A.” Also assume that the spread ratio is “1,” “−1”, and “1,” with “MAR-JUN” leg quoting. Using the equations and methods described above, the following values may be calculated for the spread order: “MAR” Long WCCP=1, “MAR” Short WCCP=0, “JUN” Long WCPP=0, “JUN” Short WCCP=1, Long WCNPP=1, and Short WCNPP=1.

Using the current positions, the working order quantity as well as the risk values computed for the spread order, the values above may be computed the equations described above.

“MAR” Long WCCP

MAX(Current Contract Position+Working Contract Buys+LWCCP for every trading strategy,0)=MAX(−6+0+1,0)=MAX(−5,0)=0.

“MAR” Short WCCP

MIN(Current Contract Position+Working Contract Sells+SWCCP for every trading strategy,0)=MIN(−6+(−2)+0,0),MIN(−8,0)=−8(Short 8).

“JUN” Long WCCP

MAX(Current Contract Position+Working Contract Buys+LWCCP for every trading strategy,0)=MAX(8+0+0,0)=MAX(8,0)=8(Long 8)

“JUN” Short WCCP

MIN(Current Contract Position+Working Contract Sells+SWCCP for every trading strategy,0)=MIN(8+0+(−1),0)=MIN(7,0)=0(Short 0)

Overall Long WCNPP

SUM(LWCNPP for every trading strategy order)+Working Buys+Current Position)=1+0+2=3(Long 3)

Overall Short WCNPP

SUM(SWCNPP for every trading strategy order)+Working Sells−Current Position=1+2−2=1(Short 1)

Overall WCNPP

MAX(LWCNPP,SWCNPP)=(3,1)=3

As explained above, each contract risk value may be compared to the corresponding preset contract limit, and each overall WCNPP may be compared to the corresponding product limit. If the limits are not exceeded, the trading strategy may be approved for execution, in which case a quoting order to buy “MAR-JUN” leg of the spread may be executed. If one of the limits is exceeded, the trading strategy may be rejected.

### IV. Risk Management

According to an example embodiment, once an offset long or short position is calculated for each quoting order and its corresponding hedge orders of a trading strategy, the risk application may set special risk indicators to be used in relation to hedge orders. For example, the risk indicators may be associated with risk values assigned to each hedge order.

According to an example embodiment, a risk value for each hedge order may be determined based on a modified position calculated based on hedge orders to be triggered by a quoting order. For example, referring back to example (iv) in Section II, a modified short product position determined based on hedge orders (“JUN,” “SEP,” and “DEC”) for “MAR” quoting order was “8.” According to an example embodiment, the modified short product position value may be divided between the hedge orders based on any desired formula. For example, the modified short product position may be equally divided between the hedge orders. Alternatively, a risk value corresponding to each hedge order may not be equal. According to the example above with the modified short position of “8,” a risk value for “JUN” may be set to “3,” a risk value for “SEP” may also be set to “3,” while a risk value for “DEC” is set to “2.”

The risk value assigned to each hedge order may be used by the risk application for pre-trade risk assessment as well as for risk management once an order for the trading strategy is entered to the market. For example, if one of the hedge orders is deleted, the risk value associated with the deleted hedge order may be used to adjust the product level risk position for the trading strategy. Similar methods may be used in relation to contract level position risk calculations and management.

### V. An Example Electronic Trading System

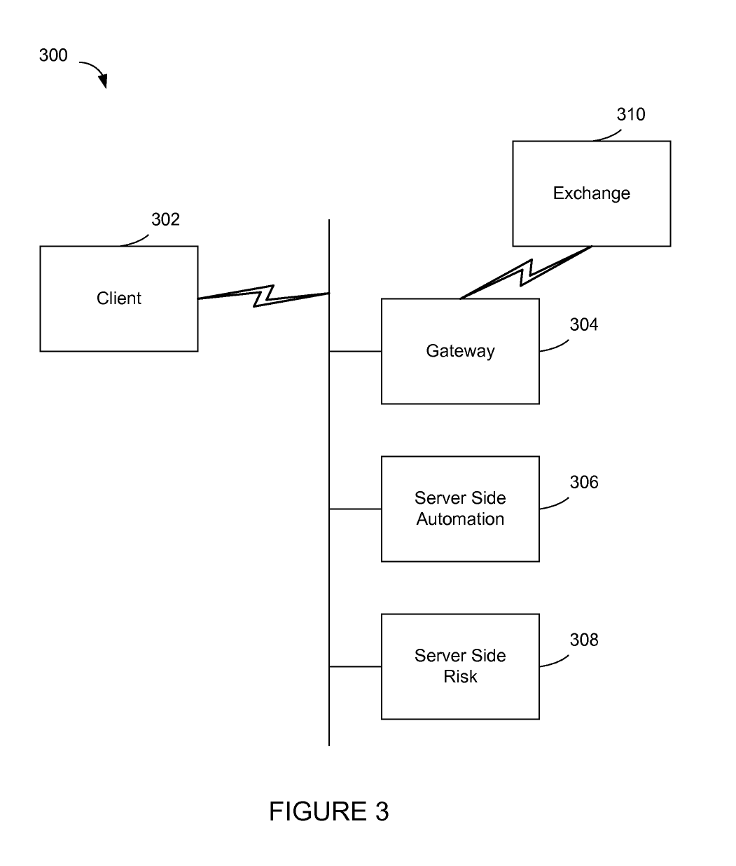

FIG. 3 illustrates an example electronic trading system 300 in which certain embodiments described herein may be employed. The system includes client device 302, gateway device 304, a server side automation device (“SSA”) 306, a server side risk device (“SSR”) 308, and an electronic exchange 310. According to the shown system, client device 302 is in communication with gateway 304. Gateway is in communication with electronic exchange 310. SSA 306 may be in communication with client device 302 and gateway 304. SSR 308 may be in communication with any of client device 302, SSA 306, and gateway 304.

According to some operations, client device 302 is adapted to send orders to buy or sell tradeable objects at exchange 310. Orders to be placed at exchange 310 via client device 302 are sent through gateway 304. In addition, market data may be sent from exchange 310 and a user can base decisions to send trade orders to exchange 310 for one or more tradeable objects. Trading decisions at client device 302 may be manual or automated. In some embodiments, orders placed via client device are risk checked utilizing techniques described herein. For instance, orders to be placed via client device 302 are risk checked so that product and contract limits are not exceeded.

According to some operations, SSA is adapted to send orders to buy or sell tradeable objects at exchange 310 on behalf of the user of client device 302. Orders to be placed at exchange via SSA 306 are sent through gateway 304. Market data may be sent from exchange 310 via gateway 304 to SSA 306. SSA 306 may monitor the market data and based decisions to send an order for a tradeable object. Trading decisions at SSA 306 are generally automated, but SSA 306 may be adapted for manual intervention by user of client device 302. In certain embodiments, orders placed via SSA 306 are risk checked using the techniques described herein. For instance, orders to be placed via SSA 306 are risk checked so that product and contract position limits are not exceeded.

Client device 302 may include one or more electronic computing platforms such as a hand-held device, laptop, personal computer, workstation with a single or multi-core processor, server with multiple processors, and/or cluster of computers, for example. A present day commercial example might include a computing device that utilizes the Windows XP Professional operating system and has at least 2 GB of memory, two dual-core or two quad-core processors, a network card, and at least 10 GB of hard drive space to accommodate software. Client device 302 may communicate with the trading network using a local area network, a wide area network, a virtual private network, a T1 line, a T3 line, a point-of presence, and/or the Internet, for example.

Client device 302 may be configured to run one or more trading applications. The trading application(s) may, for example, process market data by arranging and displaying the market data in trading and charting windows on a display screen. This processing may be based on user preferences, for example. In addition to manual style trading tools, the trading application(s) may include an automated trading tool such as an automated spread trading tool, for example. In another example, client device 302 may be a computing system running a copy of X_TRADER™, an electronic trading platform provided by Trading Technologies International, Inc. of Chicago, Ill. Regardless of the type of trading application, client device 302 may be adapted to send orders to buy and sell tradeable objects listed at exchange 310. Client device 302 may also be adapted to cancel orders, change orders, and/or query exchange 310, for example. Client device 302, including one or more trading applications, may also be configured to operate with one or more trading applications at SSA 306.

Client device 302 may include a user interface. The user interface may include one or more display devices for presenting a text-based or graphical interface to a user, for example. Display devices may include computer monitors, hand-held device displays, projectors, and/or televisions. The user interface may be used by the user to specify or review parameters for an order using a trading application. The user interface may include one or more input devices for receiving input from a user. For example, the input devices may include a keyboard, trackball, two or three-button mouse, and/or touch screen. The user interface may include other devices for interacting with a user. For example, information may be aurally provided to a user through a speaker and/or received through a microphone.

In some embodiments, client device 302 includes a risk check analyzer component to perform a risk check, such as contract and product check, to determine whether a trading strategy is approved. Client device 302 may be configured to perform multiple blocks in FIG. 1 in relation to the product level risk checking. Client device 302 may perform similar steps described in relation to the contract level risk checking described herein. Additionally, client device 302 may perform risk computations in relation to the contract risk checks described herein. Client device 302 and SSR 308 may also be configured to share responsibility to perform risk checks described herein. In other embodiments, client device 302 is not utilized to perform a risk check, but some other computing device like SSR 308 is configured to perform the risk checks on the contract and product levels. For example, SSR 308 may include a quantity identification component, a hedge quantity reduction component, and a risk check component.

SSA 306 may include one or more electronic trading platforms such as a personal computer, workstation with a single or multi-core processor, server with multiple processors, and/or cluster of computers. A present day commercial example might include a computing device that utilizes the Windows 2003 Server (Server Pack 2) operating system and has at least 4 GB of memory, two dual-core or two quad-core processors, two or more network cards with at least one pointed to the internal network and one pointed to the exchange, and at least 30 GB of hard drive space to accommodate software. SSA 306 may be used to implement automated or semi-automated trading programs. Orders may be sent directly from SSA 306 to exchange 310 through gateway 304. It should be understood that orders generated by SSA 306 are also risk-checked before they are sent to exchange 310. Others may also be sent from another computer device to exchange 310 via instructions from SSA 306, for example.

SSR 308 may include one or more electronic computing platforms such as a personal computer, workstation with a single or multi-core processor, server with multiple processors, and/or cluster of computers, for example. A present day commercial example might include a computing device that utilizes the Windows 2003 Server (Server Pack 2) operating system and has at least 4 GB of memory, two dual-core or two quad-core processors, two or more network cards with at least one pointed to the internal network and one pointed to the exchange, and at least 30 GB of hard drive space to accommodate software.

In some embodiments, SSR 308 includes a risk check analyzer component to determine whether a trading strategy is approved. SSR 308 may include a quantity identification component to receive and/or identify an order quantity to be bought or sold in relation to multiple legs of a trading strategy. Additionally, SSR 308 may determine modified order quantities of hedge orders for the contract and product risk checking. In some embodiments, client device 302 and SSA 306 and SSR 308 may share responsibility to perform various risk steps for a risk check. In other embodiments, SSR 308 is not utilized, but some other computing device like client device 302 or gateway 304 is configured to perform risk computations and analysis utilizing the techniques described herein.

Gateway 304 may include one or more electronic computing platforms such as a personal computer, workstation with a single or multi-core processor, server with multiple processors, and/or cluster of computers, for example. In certain embodiments, gateway 304 communicates with client device 302 and/or SSA 306 and/or SSR 308 using a local area network, a wide area network, a virtual private network, a T1 line, a T3 line, a point-of-presence, and/or the Internet, for example. A present day commercial example might include a computing device that utilizes the Windows 2003 Server (Server Pack 2) operating system and has at least 4 GB of memory, two dual-core or two quad-core processors, two or more network cards with at least one pointed to the internal network and one pointed to the exchange, and at least 30 GB of hard drive space to accommodate software.

Gateway 304 is adapted to communicate with client device 302 and/or SSA 306 and/or SSR 308 and exchange 310. Gateway 304 facilitates communication between the various devices on the trading network and exchange 310. For example, gateway 304 may receive orders from client device 302 and/or SSA 306 and transmit the orders to exchange 310. As another example, gateway 304 may receive market data from exchange 310 and transmit the market data to client device 302 and/or SSA 306. As previously discussed, gateway 304 may also be configured to implement certain embodiments of the present invention.

Particularly, gateway 304 may be configured to process data communicated between client device 302 and/or SSA 306 and exchange 310. For example, gateway 304 may process an order received from client device 302 and/or SSA 306 into a data format acceptable by exchange 310. Similarly, gateway 304 may transform market data in an exchange-specific format received from exchange 310 into a format understood by client device 302 and/or SSA 306. The processing of gateway 304 may also include tracking orders from client device 302 and/or SSA 306 and updating the status of the order based on fill confirmations received from exchange 310, for example. As another example, gateway 304 may coalesce market data from exchange 310 and provide it to client device 302 and/or SSA 306.

Exchange 310 is adapted to match orders to buy and sell tradeable objects. The tradeable objects may be listed for trading at exchange 310. The orders may include orders received from client device 302 and/or SSA 306, for example. Orders may be received from client device 302 and/or SSA 306 through gateway 304, for example. In addition, the orders may be received from other devices in communication with exchange 310. That is, typically exchange 310 will be in communication with a variety of other client devices (which may be similar to client device 302) or other computing devices that also provide orders to be matched. An example of exchange 310 is an electronic trading platform offered by CME Group, located in Chicago, Ill.

Exchange 310 is adapted to provide market data. The market data may be provided to the client device 302 and/or SSA 306, for example. The market data may be provided to the client device 302 and/or SSA 306 through gateway 304, for example. The market data may include data that represents the inside market, for example. The inside market is the lowest sell price (also referred to as the “best ask”) and the highest buy price (also referred to as the “best bid”) at a particular point in time. The market data may also include market depth. Market depth refers to the quantities available at other prices away from the inside market. In certain embodiments, market depth is provided for all price levels. In certain embodiments, market depth is provided for less than all price levels. For example, market depth may be provided only for the first five price levels on either side of the inside market. The market data may also include information such as the last traded price (LTP), the last traded quantity (LTQ), and order fill information.

In certain embodiments, system 300 includes more than one client device 302. For example, multiple client devices similar to the client device 302, discussed above, may be in communication with gateway 304 to send orders to the exchange 310.

In certain embodiments, system 300 includes more than one gateway 304. For example, multiple gateways similar to the gateway 304, discussed above, may be in communication with the client device 302 and/or SSA 306 and the exchange 304. Such an arrangement may be used to provide redundancy should gateway 304 fail, for example. System 300 might also include additional gateways to facilitate communication between client device 302 and/or SSA 306 and other exchanges besides exchange 310.

In certain embodiments, system 300 includes more than one exchange 310. For example, the gateway 304 may be in communication with multiple exchanges similar to the exchange 310, discussed above. Such an arrangement may allow client device 302 and/or SSA 306 to trade at more than one exchange through gateway 304, for example.

In certain embodiments, gateway 304 is part of client device 302 and/or SSA 306. For example, the components of gateway 304 may be part of the same computing platform as the client device 302 and/or SSA 306. As another example, the functionality of gateway 304 may be performed by components of the client device 302 and/or SSA 306. In certain embodiments, gateway 304 is not present. Such an arrangement may occur when the client device 302 and/or SSA 306 does not need to utilize gateway 304 to communicate with exchange 310, for example. For example, if client device 302 and/or SSA 306 have been adapted to communicate directly with exchange 310.

In certain embodiments, any of gateway 304, SSA 306, and SSR 308 is physically located at the same site as the client device 302. In certain embodiments, any of gateway 304, SSA 306, and SSR 308 is physically located at the same site as exchange 310. In certain embodiments, client device 302 is physically located at the same site as the exchange 310. In certain embodiments, any of gateway 304, SSA 306, and SSR 308 is physically located at a site separate from both the client device 302 and the exchange 310.

While not shown for the sake of clarity, in certain embodiments, system 300 may include other devices that are specific to the communications architecture such as middleware, firewalls, hubs, switches, routers, exchange-specific communication equipment, modems, security managers, and/or encryption/decryption devices.

In certain embodiments, when at least one order is rejected due to a risk check, a message or indication is provided. In certain embodiments, no message is provided except that the trading strategy fails to proceed. In certain embodiments, when at the trading strategy is approved, another message or indication is provided. For example, a risk check analyzer component may be configured to provide such messages and/or indications.

In certain embodiments, the trading strategy can be modified during execution. For example, the price, quantity, or both can be changed for an active trading strategy. Upon increasing the quantity of a working spread order, for example, a risk check is performed similar to as discussed above. If the proposed change passes the risk check, the trading strategy can be modified by adjusting order quantity in one or more tradeable objects. If the proposed change fails the risk check, then the trading strategy cannot be modified, for example.

It should be understood that one or more of the steps of the methods discussed above may be implemented alone or in combination in various forms in hardware, firmware, and/or as a set of instructions in software, for example. Certain embodiments may be provided as a set of instructions residing on a computer-readable medium, such as a memory, hard disk, CD-ROM, DVD, and/or EPROM for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for risk management, comprising:
identifying a first risk order quantity for a tradeable object associated with a quoting order, wherein the quoting order is associated with a first leg of a first trading strategy, and wherein the quoting order is to be submitted to a first electronic exchange;
identifying a second risk order quantity for the tradeable object associated with a first order to be submitted to a second electronic exchange subsequent to detection of a match for the quoting order at the first electronic exchange, wherein the second order is associated with a second leg of the first trading strategy;
determining that the first risk order quantity offsets the second risk order quantity;
determining a reduced second risk order quantity for the second order by offsetting the second risk order quantity with the first risk order quantity;
determining a risk value for the tradeable object using the first risk order quantity and the reduced second risk order quantity;
comparing the risk value with a risk limit associated with the tradeable object; and
sending the quoting order to the first electronic exchange if the risk value does not exceed the risk limit.

2. The method of claim 1, further comprising:
preventing the quoting order from being sent to the first electronic exchange if the risk value exceeds the risk limit.

3. The method of claim 1, wherein the first tradeable object and the second tradeable object are associated with the same product, wherein the risk value is a worst case net product position for the first trading strategy, and wherein the risk limit is a worst case net product position limit.

4. The method of claim 3, wherein determining the risk value comprises:
determining a long position risk value and a short position risk value using the first risk order quantity and the reduced second risk order quantity; and
determining the risk value based on the long position risk value and the short position risk value.

5. The method of claim 1, further comprising:
determining the first risk order quantity using a first risk ratio corresponding to the first tradeable object and a desired order quantity for the first trading strategy; and
determining the second risk order quantity using a second risk ratio corresponding to the second tradeable object and the desired order quantity for the first trading strategy.

6. The method of claim 5, wherein the first risk ratio is based on a first spread ratio corresponding to the quoting order, and wherein the second risk ratio is based on a second spread ratio corresponding to the first order.

7. The method of claim 1, wherein the first tradeable object and the second tradeable object are associated with the same contract, wherein the risk value is a worst case contract position for the first trading strategy, and wherein the risk limit is associated with a worst case contract position limit.

8. The method of claim 7, wherein the first order is to buy or sell the contract, and wherein the second order is to buy or sell a second trading strategy comprising a leg to buy or sell the contract.

9. The method of claim 8, wherein the second trading strategy comprises a spread trading strategy.

10. The method of claim 7, wherein the first order is to buy or sell a second trading strategy comprising a leg to buy or sell the contract, and wherein the second order is to buy or sell a third trading strategy comprising a leg to buy or sell the contract.

11. The method of claim 10, wherein at least one of the second trading strategy and the third trading strategy comprises a spread trading strategy.

12. The method of claim 1, wherein the first electronic exchange and the second electronic exchange are the same electronic exchange.

13. The method of claim 1, wherein the first electronic exchange and the second electronic exchange are different electronic exchanges.

14. The method of claim 1, wherein the first trading strategy comprises a spread trading strategy.

15. A computer readable medium having stored therein instructions executable by a processor, wherein the instructions are executable to:
identify a first risk order quantity for a tradeable object associated with a quoting order, wherein the quoting order is associated with a first leg of a first trading strategy, and wherein the quoting order is to be submitted to a first electronic exchange;
identify a second risk order quantity for the tradeable object associated with a first order to be submitted to a second electronic exchange subsequent to detection of a match for the quoting order at the first electronic exchange, wherein the second order is associated with a second leg of the first trading strategy;
determine that the first risk order quantity offsets the second risk order quantity;
determine a reduced second risk order quantity for the second order by offsetting the second risk order quantity with the first risk order quantity;
determine a risk value for the tradeable object using the first risk order quantity and the reduced second risk order quantity;
compare the risk value with a risk limit associated with the tradeable object; and
send the quoting order to the first electronic exchange if the risk value does not exceed the risk limit.

16. The computer readable medium of claim 15, wherein the instructions are further executable to:
prevent the quoting order from being sent to the first electronic exchange if the risk value exceeds the risk limit.

17. The computer readable medium of claim 15, wherein the first tradeable object and the second tradeable object are associated with the same product, wherein the risk value is a worst case net product position for the first trading strategy, and wherein the risk limit is a worst case net product position limit.

18. The computer readable medium of claim 15, wherein the first trading strategy comprises a spread trading strategy.

19. The computer readable medium of claim 15, wherein the first tradeable object and the second tradeable object are associated with the same contract, wherein the risk value is a worst case contract position, and wherein the risk limit is a worst case contract position limit.

20. The computer readable medium of claim 19, wherein the first order is to buy or sell the contract, and wherein the second order is to buy or sell a second trading strategy comprising a leg to buy or sell the contract.

21. The computer readable medium of claim 19, wherein the first order is to buy or sell a second trading strategy comprising a leg to buy or sell the contract, and wherein the second order is to buy or sell a third trading strategy comprising a leg to buy or sell the contract.
